(19) United States
(12) Patent Application Publication
(10) Pub. No.: US 2003/0133140 A1
(43) Pub. Date: Jul. 17, 2003

(54) Automatic photograph producer and producing method

(76) Inventor: Kuan-Yu Lee, Taichung (TW)

Correspondence Address: J.C. Patents, Inc., Suite 250, 4 Venture, Irvine, CA, 92618, US

(21) Appl. No.: 10/045,431

(22) Filed: Jan. 11, 2002

(51) Int. Cl. H04N 1/04; H04N 1/393

(52) U.S. Cl. 358/1.12; 358/487; 358/1.2; 358/449; 358/451; 358/488

(57) ABSTRACT

An automatic photograph producer and an operating method of the producer. The automatic photograph producer is incorporated into a four-in-one multi-function machine that includes a printer, a scanner, a photocopier and a facsimile. The automatic photograph producer comprises a platform, a top panel, a penetrating light source and a printer. The platform is a place for holding transparencies. One end of the top panel couples with one end of the platform. The penetrating light source is above the top panel for sending light to the transparency on the platform during scanning. The printer prints out an image of the scanned transparency onto a photographic paper.

### BACKGROUND OF THE INVENTION

1. Field of Invention

The present invention relates to an automatic photograph producer and a producing method. More particularly, the present invention relates to a four-in-one multifunction machine having an additional transparency-scanning device for automatic production of photographs.

2. Description of Related Art

To produce photographs from the film negatives or positives captured by a conventional camera, the film must be processed inside a dark room or developed inside a developing machine. Either method takes time and requires patience.

Following the rapid progress in image processing, techniques capable of extracting images from a film through scanning have been developed. However, digital data produced after scanning the film must be filed inside a computer. Hence, to produce a copy of the image, the image has to be retrieved from the computer file and printed using an image printer.

Although a computer can produce a hard copy of an image much quicker than that produced by developing a film using conventional technique, the user needs to spend some money on a computer system capable of scanning a photographic film and a printer capable of producing images with photographic quality. Moreover, the user must have some hardware knowledge and some understanding of the software that drives the hardware.

### SUMMARY OF THE INVENTION

Accordingly, one object of the present invention is to provide an automatic photograph producer so that a user need not wait too long or spend a great deal of money buying equipment and learning the software necessary for operating the equipment.

To achieve these and other advantages and in accordance with the purpose of the invention, as embodied and broadly described herein, the invention provides an automatic photograph producer that incorporates a four-in-one multi-function machine. The four functions of the four-in-one multi-function machine include printing, scanning, photocopying and facsimile. The automatic photograph producer includes a platform, a top cover, a penetrating light source and a built-in printing device. The platform is a place for placing a transparency. The top panel, the penetrating light source and the printing device are connected together at one end of the platform. The transparency includes photographic film.

The penetrating light source is mounted on the top panel. The penetrating light source provides the necessary lighting for the transparency atop the platform during scanning. The printing device is responsible for printing out an image of the scanned transparency. Therefore, an actual photograph of the scanned image is immediately obtained.

If, however, the user needs to turn a large number of photographic film into photographs, an automatic feeder and a position detector may also be incorporated

The automatic feeder has a storage area for holding a small number of photographic film The automatic feeder is capable of feeding a photographic film from the storage area into the platform sequentially and the position detector is capable of determining if the fed photographic film is in a proper position for scanning.

This invention also provides a method of operating an automatic photograph producer to produce photographs. The method includes activating an execution button, scanning a transparency using a penetrating light source and printing out a photograph of the scanned transparency using a printer.

In brief, this invention incorporates an additional penetrating light source into an existing four-in-one multi-function machine. In the presence of the penetrating light source, the machine is able to scan any transparency and print out the scanned transparency through a built-in printer. Ultimately, a high-resolution photograph is produced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic side view showing an automatic photograph producer having a transparency-scanning device for scanning photographic film according to a first preferred embodiment of this invention;

FIG. 2 is a flow chart showing the steps for producing photographs using an automatic photograph producer according to a second preferred embodiment of this invention,

FIG. 3 is a flow chart showing the steps for producing photographs using an automatic photograph producer according to a third preferred embodiment of this invention;

FIG. 4a is a schematic top view of an operating panel design for the four-in-one multi-function machine according to this invention; and

FIG. 4b is a schematic top view of an alternative operating panel design for the four-in-one multi-function machine according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

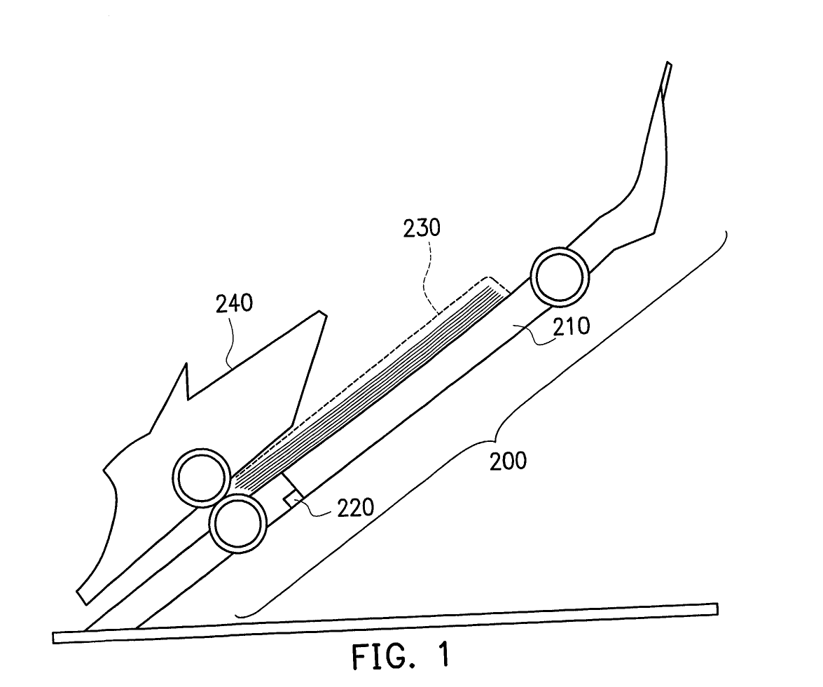

FIG. 1 is a schematic side view showing an automatic photograph producer having a transparency-scanning device for scanning photographic film according to a first preferred embodiment of this invention. The automatic photograph producer is incorporated into a four-in-one multi-function machine. The four functions of the multi-function machine include printing, scanning, photocopying and facsimile.

The automatic photograph producer includes a platform 100, a top panel 200, a penetrating light source 210 and a printer (not shown). One end of the top panel 200 is coupled to one end of the platform 100.

The printer is an in-built device within the four-in-one multi-function machine. The platform 100 is a place for putting transparencies such as film negatives, film positives or transparent documents that permit light to penetrate. The penetrating light source 210 is mounted on the top panel 200 so that light from the light source 210 projects onto the transparency on the platform 100 during a scanning operation. The printer (not shown) prints out an image of the scanned transparency on paper to serve as a hard copy. The penetrating light source 210, for example, can be a universal transparency cover (UTC) panel or an artie transparency adapter (XPA) mask.

The penetrating light source of most scanners is positioned to operate as a reflective light source. In this invention, the penetrating light source 210 provides necessary lighting for scanning a transparency so that the multi-function machine may capture an image of the transparency through a light sensor. The reflective light source of most scanners projects light onto a non-transparent document and obtains an image by capturing the reflected light. The procedure for scanning a non-transparent document is similar to the scanning of a transparency and hence detailed description is omitted here.

Because a multi-function machine capable of printing, scanning, photocopying and facsimile is used in this invention, an image captured as digital data through a scanning operation may be directly printed onto a paper to serve as a permanent hard copy. A printing paper having photographic quality may be used so that the printed output will look identical to a photograph chemically developed from a photographic film

To produce photographs of a batch of photographic film in a single operation, the automatic photograph producer may also includes a storage area 230, an automatic feeder 240 and a position detector 220.

The storage area 230 is located above the top panel 200. The storage area is capable of holding a number of transparencies. The automatic feeder 240 towers over the top panel 200 above the storage area 230 such that the transparencies can be fed from the storage area 230 to the platform 100 sequentially. The position detector 220 is a device for checking the position of transparency on the platform 1 00 so that the transparency is properly placed for scanning.

Using the aforementioned devices, scanning a plurality of transparencies and printing all of them out in a single operation is possible. Note that although the automatic feeder 240 and the storage area 230 are formed over the top panel 200, this is not the only possible configuration. In fact, the automatic feeder 240 and storage area 230 may be anywhere as long as transparencies are sequentially transferred to the platform 100.

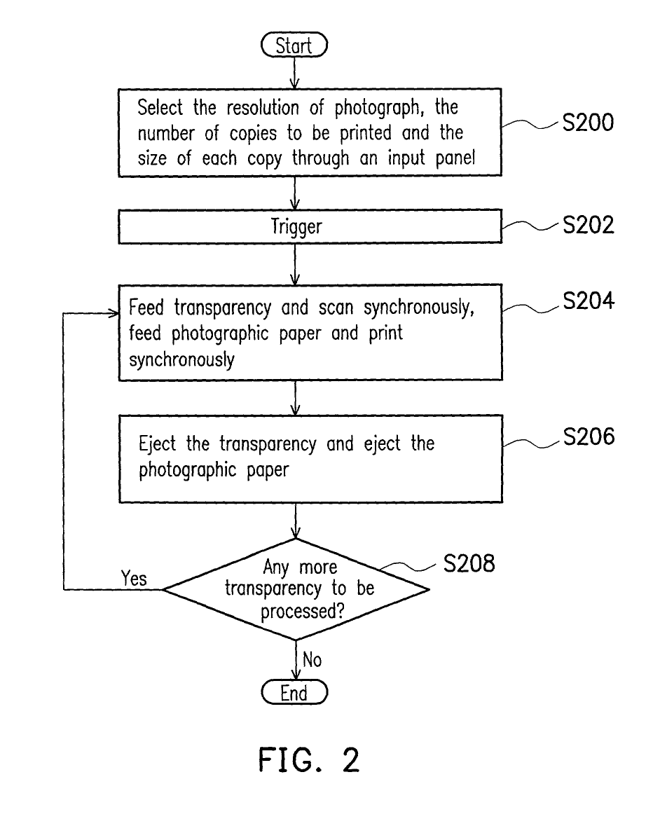

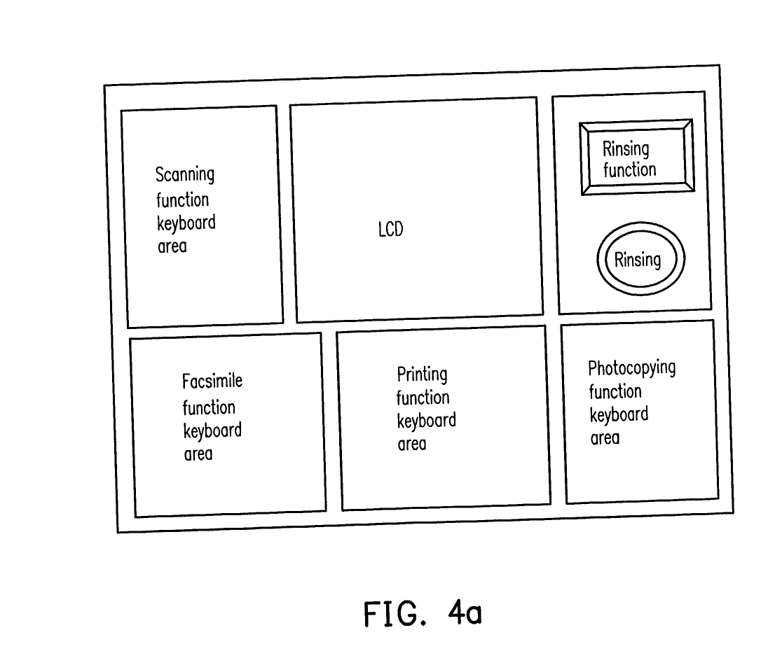

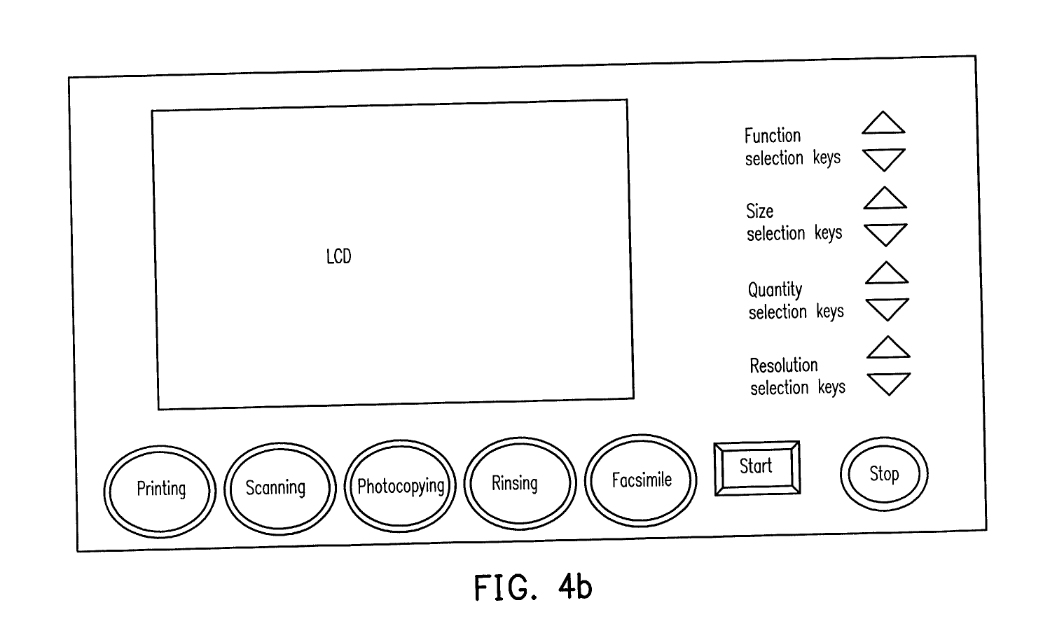

FIG. 2 is a flow chart showing the steps for producing photographs using an automatic photograph producer according to a second preferred embodiment of this invention. FIG. 4a is a schematic top view of an operating panel design for the four-in-one multi-function machine according to this invention; and FIG. 4b is a schematic top view of an alternative operating panel design for the four-in-one multi-function machine according to this invention.

Automatic production of photographs includes a number of steps. First, a button for executing a rinsing operation as shown in FIG. 4a is pushed (in step s202). In step s204, a transparency and a photographic printing paper are fed into respective areas of the four-in-one multi-function machine so that scanning and printing operations are conducted concurrently. In step s206, the transparency and the photographic printing paper are ejected. In step s208, if some transparencies are still pending in the storage area, the steps from s204 to s206 are again executed until there are no more pending transparencies in the storage area.

If the operating panel has a configuration shown in FIG. 4b, the user may change the preset parameters for producing photographs before triggering the rinsing operation (in step s200). This includes the selection of the printing paper resolution, the number of printed copies and the size of each print.

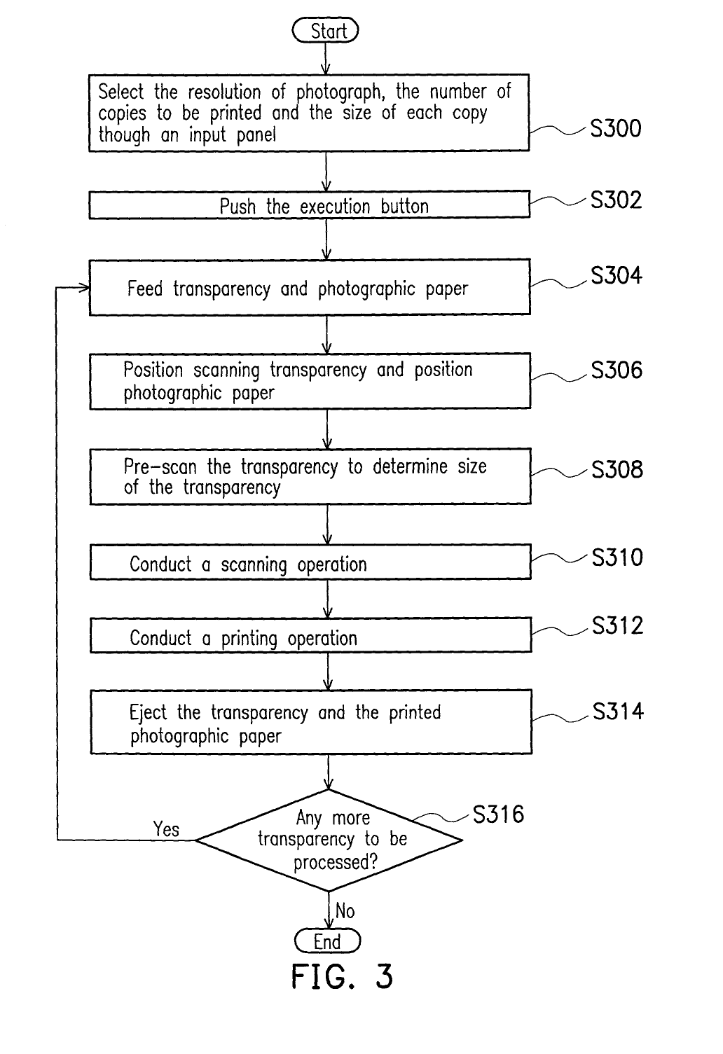

FIG. 3 is a flow chart showing the steps for producing photographs using an automatic photograph producer according to a third preferred embodiment of this invention.

In step s300, preset parameters for producing desired photographs are changed using the control panels shown in either FIG. 4a or FIG. 4b. In step s302, an execution button is pressed and hence preparatory actions from s304 to s308 are executed. These preparatory actions include the following steps. In step s304, transparency and printing paper are fed into the four-in-one multi-function machine. In step s306, the transparency is positioned for scanning and the printing paper is positioned for printing. In step s308, the transparency is pre-scanned to determine the size of the transparency After the preparatory actions are completed, a penetrating light source is utilized to scan the transparency in step s310. Finally, in step s312, the scanned transparency is printed on the photographic paper.

After printing out the scanned transparency onto photographic printing paper (in step s312), the scanned photographic film and the printed photographic paper are ejected from their respective compartments in step s314. If other transparencies are still pending for processing in step s316, the steps from s304 to s312 are executed again until no pending transparencies are left.

In conclusion, one major advantage of this invention is the incorporation of a photograph producer into an existing four-in-one multi-function machine. Through a penetrating light source and a built-in printer, a transparency is scanned and the resulting image is printed out using printing paper. Hence, a high-quality photograph is produced without having to wait for dark room processing or machine developing of photographic film and there is no need to procure an expensive computer, a scanner and a printer for photographic production.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents,

What is claimed is:

1. An automatic photograph producer incorporated with a four-in-one multi-function machine that includes a printer, scanner, photocopier and a facsimile, the automatic photograph producer comprising:
a platform;
a top panel;
a storage area for temporarily holding a plurality of transparencies;
an automatic feeder for transporting the transparencies stored inside the storage area to the platform sequentially;
a penetrating light source on the top panel for projecting light onto the transparency on the platform during a scanning operation; and
a printer for printing out an image of the scanned transparency.

2. The automatic photograph producer of claim 1, wherein the transparency includes film positives, film negatives and transparent documents.

3. The automatic photograph producer of claim 1, wherein the penetrating light source includes a light panel.

4. The automatic photograph producer of claim 1, wherein the penetrating light source includes a mask.

5. The automatic photograph producer of claim 1, wherein the storage area is above the top panel

6. The automatic photograph producer of claim 5, wherein the automatic feeder mounts on the top panel enclosing the storage area.

7. The automatic photograph producer of claim 1, wherein the producer further includes a position detector mounted on the top panel for determining if the transparency placed on the platform is properly positioned for scanning.

8. A method for producing photographs automatically using an automatic photograph producer together with a four-in-one multi-function machine that includes a printer, scanner, photocopier and a facsimile, the method comprising the steps of:
pushing an execution button;
scanning a transparency with light emitted from a penetrating light source; and
printing out the image obtained by scanning the transparency image on a printing paper.

9. The method of claim 8, wherein the method further includes the step of executing preparatory actions, the preparatory actions include:
feeding a transparency and a photographic printing paper into the four-in-one multi-function machine;
scanning the transparency and printing an image of the scanned transparency on the photographic printing paper; and
pre-scanning the transparency to determine the size of the transparency.

10. The method of claim 9, wherein after printing out an image of the scanned transparency further includes the step of:
ejecting the transparency and the printed photographic paper;
executing the preparatory actions, the scanning and the printing operations again until no transparencies await processing.

11. The method of claim 9, wherein before the step of pushing the execution button, further includes the step of changing the values of a set of preset parameters.

12. The method of claim 1 1, wherein the preset parameters include the resolution of the photographic paper to be printed on, the number of copies to be printed and size of each copy.
